(19) United States
(12) Patent Application Publication
(10) Pub. No.: US 2026/0286115 A1
(43) Pub. Date: Sep. 24, 2026

(54) PROPYLENE-BASED COPOLYMER COMPOSITON

(71) Applicant: Basell Poliolefine Italia S.r.l., Milano (IT)

(72) Inventors: Marco Bocchino, Ferrara (IT); Claudio Cavalieri, Ferrara (IT); Antonio Riemma, Ferrara (IT); Alberta De Capua, Ferrara (IT); Eleonora Ciaccia, Ferrara (IT); Davide Tartari, Ferrara (IT); Cristina Cova, Ferrara (IT); Alessia Di Capua, Ferrara (IT); Marco Ciarafoni, Ferrara (IT); Giampaolo Pellegatti, Ferrara (IT)

(73) Assignee: Basell Poliolefine Italia S.r.l., Milano (IT)

(21) Appl. No.: 19/478,181

(22) PCT Filed: Apr. 5, 2024
(86) PCT No.: PCT/EP2024/059302

§ 371 Date: Oct. 23, 2025

(30) Foreign Application Priority Data
Apr. 26, 2023 (EP) 23170149.1

(51) Int. Cl. C08L 23/14; C08L 23/16

(52) U.S. Cl. CPC C08L 23/142; C08L 23/16; C08L 2205/025; C08L 2314/02

(57) ABSTRACT

A polyolefin composition made from or containing:
A) from 50 to 80 wt % of a copolymer of propylene with ethylene, having:
i) the content of ethylene between 2.5 and 6.5 wt %; and
B) from 20 to 50 wt % of a propylene ethylene copolymer containing from 40.0 wt % to 65.0 wt % of ethylene derived units;
wherein the polyolefin composition, having:
i) a content of ethylene derived units between 12.0 and 35 wt %;
ii) a content of ethylene derived units in the fraction soluble in xylene at 25° between 35.0 and 56.0 wt %;
iii) a melt flow rate ranging from 0.1 to 3.0 g/10 min;
iv) xylene solubles at 25° C. ranging from 23 to 43.0 wt %;
v) an intrinsic viscosity of the fraction soluble in xylene at 25° C. ranging from 7.7 to 15.0 dl/g; and
vi) an intrinsic viscosity of the whole polyolefin composition ranging from 7.7 to 15.0 dl/g.

### FIELD OF THE INVENTION

In general, the present disclosure relates to the field of chemistry. More specifically, the present disclosure relates to polymer chemistry. In particular, the present disclosure relates to a composition made from or containing propylene ethylene copolymers.

### BACKGROUND OF THE INVENTION

In some instances, different applications use tailored polymers, thereby achieving the individual demanding properties.

In some instances, abrasion resistance is a characteristic of articles made from or containing polymeric materials. In some instances, the polymeric materials are made from or containing polypropylene. In some instances, the articles are used in the automotive industry and include durable plastic products for use in manufacturing exterior and interior parts. In some instances, the durable plastic products are part of moving parts such as gears.

### SUMMARY OF THE INVENTION

In a general embodiment, the present disclosure provides a polyolefin composition made from or containing:
A) from 50 wt % to 80 wt % of a copolymer of propylene with ethylene, having:
   i) a content of ethylene derived units, measured by NMR, between 2.5 wt % and 6.5 wt %, based upon the total weight of the copolymer (A); and
B) from 20 wt % to 50 wt % of a propylene ethylene copolymer containing from 40.0 wt % to 65.0 wt % of ethylene derived units, measured by NMR;
wherein the polyolefin composition, having:
   i) a content of ethylene derived units, measured by NMR, between 12.0 wt % and 35 wt %, based upon the total weight of the polyolefin composition;
   ii) a content of ethylene derived units, measured by NMR, in the fraction soluble in xylene at 25° between 35.0 wt % and 56.0 wt %, based upon the total weight of soluble fraction;
   iii) a melt flow rate (ISO 1133 (230° C., 21.6 kg)) ranging from 0.1 g/10 min to 3.0 g/10 min;
   iv) xylene solubles at 25° C. ranging from 23 wt % to 43.0 wt %, based upon the total weight of the polyolefin composition;
   v) an intrinsic viscosity, measured in tetrahydronaphthalene at 135° C., of the fraction soluble in xylene at 25° C. ranging from 7.7 dl/g to 15.0 dl/g; and
   vi) an intrinsic viscosity, measured in tetrahydronaphthalene at 135° C., of the whole polyolefin composition ranging from 7.7 dl/g to 15.0 dl/g;
the sum A+B being 100.

### DETAILED DESCRIPTION OF THE INVENTION

In some embodiments, the present disclosure provides a polyolefin composition made from or containing:
A) from 50 wt % to 80 wt %; alternatively from 57 wt % to 77 wt %; alternatively from 63 wt % to 72 wt %; of a copolymer of propylene with ethylene, having:
   i) a content of ethylene derived units, measured by NMR, between 2.5 wt % and 6.5 wt %; alternatively between 3.5 wt % and 5.5 wt %; alternatively between 3.8 wt % and 5.0 wt %, based upon the total weight of the copolymer (A); and
B) from 20 wt % to 50 wt %; alternatively from 23 wt % to 43 wt %; alternatively from 28 wt % to 37 wt %; of a propylene ethylene copolymer containing from 40.0 wt % to 65.0 wt %; alternatively from 45 wt % to 58 wt %; alternatively from 48 wt % to 55 wt %; of ethylene derived units, measured by NMR;
wherein the polyolefin composition, having:
   i) a content of ethylene derived units, measured by NMR, between 12.0 wt % and 35 wt %; alternatively between 15.0 wt % and 30 wt %; alternatively between 19.0 wt % and 28.0 wt %, based upon the total weight of the polyolefin composition;
   ii) a content of ethylene derived units, measured by NMR, in the fraction soluble in xylene at 25° between 35.0 wt % and 56.0 wt %; alternatively between 38.0 wt % and 51.0 wt %; alternatively between 43.0 wt % and 49.0 wt %, based upon the total weight of soluble fraction;
   iii) a melt flow rate (ISO 1133 (230° C., 21.6 kg)) ranging from 0.1 g/10 min to 3.0 g/10 min; alternatively from 0.5 g/10 min to 2.5 g/10 min; alternatively from 0.8 g/10 min to 1.8 g/10 min;
   iv) xylene solubles at 25° C. ranging from 23 wt % to 43.0 wt %; alternatively ranging from 28 wt % to 40.0 wt %; alternatively ranging from 29.5 wt % to 28.5 wt %, based upon the total weight of the polyolefin composition;
   v) an intrinsic viscosity, measured in tetrahydronaphthalene at 135° C., of the fraction soluble in xylene at 25° C. ranging from 7.7 dl/g to 15.0 dl/g; alternatively ranging from 7.9 dl/g to 13.0 dl/g; alternatively ranging from 8.1 dl/g to 11.5 dl/g; and
   vi) an intrinsic viscosity, measured in tetrahydronaphthalene at 135° C., of the whole polyolefin composition ranging from 7.7 dl/g to 15.0 dl/g; alternatively ranging from 7.9 dl/g to 13.0 dl/g; alternatively ranging from 8.1 dl/g to 11.5 dl/g;
the sum A+B being 100.

As used herein, the term “copolymer” refers to a bipolymer containing two monomers, propylene and ethylene.

In some embodiments, the polyolefin composition has an intrinsic viscosity, measured in tetrahydronaphthalene at 135° C., of the of the fraction insoluble in xylene at 25° C. ranging from 6.5 dl/g to 11.3 dl/g; alternatively ranging from 6.8 dl/g to 10.3 dl/g; alternatively ranging from 7.2 dl/g to 9.5 dl/g.

In some embodiments, the polyolefin composition has a content of ethylene derived units, measured by NMR, of the fraction insoluble in xylene at 25° C. between 8.3 wt % and 17.3 wt %; alternatively between 10.5 wt % and 15.5 wt %; alternatively between 12.2 wt % and 14.6 wt %.

In some embodiments, the polyolefin composition has a low value of abrasion resistance, measured according to ISO 15527:2007. In some embodiments, the value of average abrasion index, measured according to ISO 15527:2007, on compression molded plaque is lower than 150; alternatively lower than 100; alternatively lower than 93. In some embodiments, the higher value of average abrasion index, measured according to ISO 15527:2007, is 10.

In some embodiments, the propylene copolymer has a Charpy impact test at 23° C. ranging from 40 kJ/m² to 70.0 KJ/m²; alternatively from 50.5 kJ/m² to 65.0 KJ/m².

In some embodiments, the propylene copolymer has a haze value, measured on 1 mm plaque, between 37.0% and 67.4%; alternatively between 47.0% and 60.4%.

In some embodiments, the polyolefin composition is used for producing molded articles. In some embodiments, the present disclosure provides a molded article made from or containing the polyolefin composition. In some embodiments, the molded articles are selected from the group consisting of injection molded articles, blow molded articles, and compression molded articles. In some embodiments, the molded article is a compression molded article.

In some embodiments, the polyolefin composition is used for producing molded, automotive articles. In some embodiments, the automotive articles are subjected to movement.

In some embodiments, the polyolefin composition is prepared by blending components A) and B). In some embodiments, components (A) and (B) are prepared in a continuous sequential polymerization process, wherein component A) is prepared in a first reactor and component (B) is prepared in a second reactor in the presence of component A), operating in gas phase, in liquid phase in the presence or not of inert diluent, or by mixed liquid-gas techniques.

In some embodiments, the polymerization of A) and B) is carried out in the presence of Ziegler-Natta catalysts. The catalysts are made from or containing a solid catalyst component made from or containing a titanium compound having a titanium-halogen bond and an electron-donor compound. The titanium compound and the electron-donor compound are supported on a magnesium halide in active form. The Ziegler-Natta catalysts are used with an organoaluminum compound as a cocatalyst. In some embodiments, the organoaluminum compound is an aluminum alkyl compound.

An external donor is optionally added.

In some embodiments, the catalysts yield a polypropylene with a value of xylene insolubility at ambient temperature greater than 90%, alternatively greater than 95%.

In some embodiments, the catalysts are as described in U.S. Pat. No. 4,399,054 and European Patent No. 45977. In some embodiments, the catalysts are as described in U.S. Pat. No. 4,472,524.

In some embodiments, the solid catalyst components are made from or containing electron-donors (internal donors) selected from the group consisting of ethers, ketones, lactones, compounds containing N, P and/or S atoms, and esters of mono- and dicarboxylic acids.

In some embodiments, the electron-donor compounds are esters of succinic acid (succinates). In some embodiments, the succinate has formula (I) below

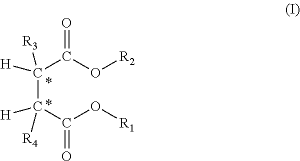

wherein the radicals R₁ and R₂, equal to or different from each other, are a C1-C20 linear or branched alkyl, alkenyl, cycloalkyl, aryl, arylalkyl or alkylaryl group, optionally containing heteroatoms; and the radicals R₃ and R₄, equal to or different from each other, are C1-C20 alkyl, C3-C20 cycloalkyl, C5-C20 aryl, arylalkyl or alkylaryl group with the proviso that at least one of R3 and R4 is a branched alkyl. In some embodiments, the compounds are, with respect to the two asymmetric carbon atoms identified in the structure of formula (I), stereoisomers of the type (S,R) or (R,S).

In some embodiments, R₁ and R₂ are selected from the group consisting of C1-C8 alkyl, cycloalkyl, aryl, arylalkyl and alkylaryl groups. In some embodiments, R₁ and R₂ are selected from primary alkyls, alternatively branched primary alkyls. In some embodiments, R₁ and R₂ groups are selected from the group consisting of methyl, ethyl, n-propyl, n-butyl, isobutyl, neopentyl, and 2-ethylhexyl. In some embodiments, R₁ and R₂ groups are selected from the group consisting of ethyl, isobutyl, and neopentyl.

In some embodiments, the R₃ radical, the R₄ radical, or both radicals are secondary alkyls or cycloalkyls. In some embodiments, the secondary alkyls are selected from the group consisting of isopropyl, sec-butyl, 2-pentyl, and 3-pentyl. In some embodiments, the cycloalkyls are selected from the group consisting of cyclohexyl, cyclopentyl, and cyclohexylmethyl.

In some embodiments, the (S,R) (S,R) forms pure or in mixture, optionally in racemic form, of diethyl 2,3-bis(trimethylsilyl) succinate, diethyl 2,3-bis(2-ethylbutyl) succinate, diethyl 2,3-dibenzylsuccinate, diethyl 2,3-diisopropylsuccinate, diisobutyl 2,3-diisopropylsuccinate, diethyl 2,3-bis(cyclohexylmethyl) succinate, diethyl 2,3-diisobutylsuccinate, diethyl 2,3-dineopentylsuccinate, diethyl 2,3-dicyclopentylsuccinate, and diethyl 2,3-dicyclohexylsuccinate.

In some embodiments, the electron-donor compounds are esters of phthalic acid and 1,3-diethers of formula:

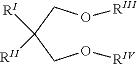

wherein R^{I} and R^{II} are the same or different and are C₁-C₁₈ alkyl, C₃-C₁₈ cycloalkyl or C₇-C₁₈ aryl radicals; R^{III} and R^{IV} are the same or different and are C₁-C₄ alkyl radicals; or are the 1,3-diethers wherein the carbon atom in position 2 belongs to a cyclic or polycyclic structure made up of 5, 6, or 7 carbon atoms, or of 5-n or 6-n′ carbon atoms, and respectively n nitrogen atoms and n′ heteroatoms selected from the group consisting of N, O, S and Si, where n is 1 or 2 and n′ is 1, 2, or 3, the structure containing two or three unsaturations (cyclopolyenic structure), and optionally being condensed with other cyclic structures, or substituted with one or more substituents selected from the group consisting of linear or branched alkyl radicals; cycloalkyl, aryl, aralkyl, alkaryl radicals and halogens, or being condensed with other cyclic structures and substituted with one or more of the above-mentioned substituents; one or more of the above-mentioned alkyl, cycloalkyl, aryl, aralkyl, or alkaryl radicals and the condensed cyclic structures optionally containing one or more heteroatom(s) as substitutes for carbon or hydrogen atoms, or both. In some embodiments, the substituents are bonded to the condensed cyclic structures.

In some embodiments, the ethers are selected from the ethers described in European Patent Application Nos. 361493 and 728769.

In some embodiments, the diethers are selected from the group consisting of 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis (methoxymethyl) fluorene.

In some embodiments, the electron-donor compounds are phthalic acid esters. In some embodiments, the phthalic acid esters are selected from the group consisting of diisobutyl phthalate, dioctyl phthalate, diphenyl phthalate, and benzylbutyl phthalate.

In some embodiments, a MgCl₂·nROH adduct is reacted with an excess of TiCl₄ containing the electron-donor compound. In some embodiments, the adduct is in the form of spheroidal particles. In some embodiments, n is from 1 to 3. In some embodiments, ROH is selected from the group consisting of ethanol, butanol, and isobutanol. In some embodiments, the reaction temperature is from 80 to 120° C. The solid is then isolated and reacted once more with TiCl₄, in the presence or absence of the electron-donor compound, after which the reaction product is separated and washed with aliquots of a hydrocarbon until the chlorine ions have disappeared.

In some embodiments and in the solid catalyst component, the titanium compound, expressed as Ti, is present in an amount from 0.5 to 10% by weight. In some embodiments, the quantity of electron-donor compound, which remains fixed on the solid catalyst component, is 5 to 20% by moles with respect to the magnesium dihalide.

In some embodiments, the titanium compounds, used for the preparation of the solid catalyst component, are selected from the group consisting of halides of titanium and halogen alcoholates of titanium. In some embodiments, the titanium compound is titanium tetrachloride.

In some embodiments, the reactions form a magnesium halide in active form. In some embodiments, magnesium halide in active form results from reactions starting with magnesium compounds other than halides, such as magnesium carboxylates.

In some embodiments, the Al-alkyl compounds used as co-catalysts are made from or containing Al-trialkyls or linear or cyclic Al-alkyl compounds. In some embodiments, the Al-trialkyls are selected from the group consisting of Al-triethyl, Al-triisobutyl, and Al-tri-n-butyl. In some embodiments, the linear or cyclic Al-alkyl compounds contain two or more Al atoms bonded to each other by O or N atoms, or SO₄ or SO₃ groups.

In some embodiments, the Al-alkyl compound is used in a quantity such that the Al/Ti ratio is from 1 to 1000.

In some embodiments, the electron-donor compounds, used as external donors, are selected from the group consisting of aromatic acid esters and silicon compounds. In some embodiments, the aromatic acid esters are alkyl benzoates. In some embodiments, the silicon compounds contain at least one Si—OR bond, where R is a hydrocarbon radical.

In some embodiments, the silicon compounds are selected from the group consisting of (tert-butyl)₂Si(OCH₃)₂, (cyclohexyl)(methyl)Si (OCH₃)₂, (cyclopentyl)₂Si(OCH₃)₂, (phenyl)₂Si(OCH₃)₂ and (1,1,2-trimethylpropyl)Si(OCH₃)₃.

In some embodiments, the internal donor is a 1,3-diether and the external donors are omitted.

In some embodiments, the component A) is prepared by using catalysts containing a phthalate, as internal donor, and (cyclopentyl)₂Si(OCH₃)₂, as outside donor. In some embodiments, the component A) is prepared by using catalysts containing 1,3-diethers as internal donors.

In some embodiments, the Ziegler-Natta catalyst is a solid catalyst component made from or containing a magnesium halide, a titanium compound having a Ti-halogen bond, and at least two electron donor compounds selected from succinates and the other being selected from 1,3 diethers.

The following examples are given for illustration without limiting purpose.

### EXAMPLE

### Characterization Methods

### Melting Temperature and Crystallization Temperature

### Determined by Differential Scanning Calorimetry (DSC)

A sample, weighing 6±1 mg, was heated to 220±1° C. at a rate of 20° C./min and kept at 220±1° C. for 2 minutes in nitrogen stream. Thereafter, the sample was cooled at a rate of 20° C./min to 40±2° C. The sample was maintained at this temperature for 2 min, thereby permitting the sample to crystallize. Then, the sample was again fused at a temperature rise rate of 20° C./min up to 220° C.±1. The melting scan was recorded. A thermogram was obtained. The melting temperatures and crystallization temperatures were read.
Melt Flow Rate: Determined according to the method ISO 1133 (230° C., 21.6 kg).

### Xylene-Soluble Fraction (XS) at 25° C.

Xylene Solubles at 25° C. were determined according to ISO 16152:2005; with solution volume of 250 ml, precipitation at 25° C. for 20 minutes, including 10 minutes with the solution in agitation (magnetic stirrer), and drying at 70° C.

### Intrinsic Viscosity (I.V.)

The sample was dissolved by tetrahydronaphthalene at 135° C. and then poured into the capillary viscometer.

The viscometer tube (Ubbelohde type) was surrounded by a cylindrical glass jacket, which permitted temperature control with a circulating thermostatic liquid.

The downward passage of the meniscus was timed by a photoelectric device. The passage of the meniscus in front of the upper lamp started the counter, which had a quartz crystal oscillator. The counter stopped as the meniscus passed the lower lamp. The efflux time was registered and converted into a value of intrinsic viscosity.

### Ethylene Content in the Copolymers

13C NMR spectra were acquired on a Bruker AV-600 spectrometer equipped with cryoprobe, operating at 160.91 MHz in the Fourier transform mode at 120° C.

The peak of the SBB carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing ¹H-¹³C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 8-titanium trichloride-diethyl-aluminum chloride” M. Kakugo, Y. Naito, K. Mizunuma and T. Miyatake, Macromolecules, 1982, 15, 1150) using the following equations:

$$PPP = 100 T ββ / S PPE = 100 T βδ / S EPE = 100 T δδ / S$$

$$PEP = 100 S ββ / S = 100 S βδ / S EEE = 100 ( 0.25 S γδ + 0.5 S δδ ) / S$$

$$S = T ββ + T βδ + T δ δ + S β β + S β δ + 0.25 S γδ + 0.5 S δδ$$

The molar percentage of ethylene content was evaluated using the following equation:

$$E \% mol = 100 * [ PEP + PEE + EEE ]$$

The weight percentage of ethylene content was evaluated using the following equation:

$$100 * E \% mol * MWE$$

$$E \% wt = E \% mol * MWE + P \% mol * MWP$$

where P % mol is the molar percentage of propylene content, while MWE and MWP are the molecular weights of ethylene and propylene, respectively.

The product of reactivity ratio r1r2 was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of propylene sequences was calculated as mm content from the ratio of the PPP mmTββ (28.90-29.65 ppm) and the whole Tββ (29.80-28.37 ppm).

The content of ethylene of component B) was calculated by using the relation:

$${C}_{2 tot} = {X}_{A} {C}_{2 A} + {X}_{B} {C}_{2 B} ;$$

wherein C₂ₜₒₜ is the amount of ethylene in the whole composition C_{2A} and C_{2B} are the amount of component A and B and X_{A} and X_{B} are the amounts of components A and B (A+B=1)
Preparation of injection molded specimens: test specimens 80×10×4 mm were obtained according to the method ISO 1873-2:2007.
Charpy Impact test at 23° C.: measured according to ISO 179-1:2010 on injection molded specimens.

### Haze

Measured according to ASTM D1003 on 1 mm injection molded plaque.

### Example 1

### Procedure for the Preparation of the Solid Catalyst Component

The solid catalyst was prepared as described for Example 10 of Patent Cooperation Treaty Publication No. WO 00/63261. Triethylaluminum (TEAL) was used as co-catalyst and dicyclopentyldimethoxysilane as external donor, with the weight ratios indicated in Table 1.

### Polymerization

The polymerization run was conducted in continuous mode in a series of three reactors, equipped with devices to transfer the product from a reactor to a next reactor immediately next to the current reactor. The first two reactors were liquid phase reactors, and the third reactor was a fluid bed gas phase reactor. Component (A) was prepared in the first and second reactors. The first and second reactors had the same polymerization parameters. Component (B) was prepared in the third reactor.

Hydrogen was used as a molecular weight regulator.

The gas phase (propylene, ethylene and hydrogen) was continuously analyzed via gas-chromatography.

At the end of the run, the powder was discharged and dried under a nitrogen flow.

The main polymerization conditions are reported in Table1.

TABLE 1

| | | Ex1 |
|---|---|---|
| TEAL/solid catalyst component weight ratio | | 11.8 |
| TEAL/DCPMS weight ratio | | 3 |
| Liquid phase reactor 1 | | |
| Polymerization temperature | ° C. | 65 |
| Pressure | Bar-g | 39 |
| Residence time | minutes | 50 |
| H2 feed | molppm | <10 |
| Liquid phase reactor 2 | | |
| Polymerization temperature | ° C. | 68 |
| Pressure | Bar-g | 39 |
| Residence time | minutes | 25 |
| H2 feed | molppm | 1100 |
| Gas phase reactor | | |
| Polymerization temperature | ° C. | 75 |
| Pressure | Barg | 13 |
| Residence time | min | 28 |
| C2/(C2 + C3) | Mol ratio | 0.45 |
| H2/C2 | Mol ratio | <0.001 |

C2 = ethylene;
C3 = propylene;
H2 = hydrogen

TABLE 2
reports the features of the compositions of Example 1.

| Example | | Ex 1 |
|---|---|---|
| Component A) | | |
| Spli | | |
| Ethylene content | wt % | 4.1 |
| Melting temperature | ° C. | 139.5 |
| Component B) | | |
| split | wt % | 33 |
| Ethylene content in component B)* | wt % | 51.0 |
| Property of the composition | | |
| Ethylene content | wt % | 19.6 |
| Ethylene content on the xylene soluble fraction | wt % | 46.9 |
| MFR | g/10′ | 1.19 |
| XSIV (intrinsic viscosity of XS) | dl/g | 8.8 |
| IV (whole composition) | dl/g | 8.23 |
| IV fraction insoluble in xylene at 25° C. | dl/g | 7.83 |
| Ethylene content on the xylene insoluble fraction | wt % | 13.2 |
| Haze (1 mm plaque) | % | 57.6 |
| Charpy impact strength 23° C. | Kj/m² | 63.7 |

*calculated

Abrasion test, according to ISO 15527:2007, was measured on compression molded plaque at 250° C., produced with polymers of Example 1 and Comparative Example 2. The results are reported in Table 3.

TABLE 3

| Example | 1 | Comp 2 |
|---|---|---|
| Abrasion index min | 91 | 105 |
| Abrasion index max | 82 | 103 |
| Abrasion index average | 87 | 1074 |

Comparative Example 2 was LP UHM 5000, an ultra-high molecular weight polyethylene designed to have a high abrasion resistance.

What is claimed is:

1. A polyolefin composition comprising:
A) from 50 wt % to 80 wt %; of a copolymer of propylene with ethylene, having:
i) a content of ethylene derived units, measured by NMR, between 2.5 wt % and 6.5 wt %, based upon the total weight of the copolymer (A); and
B) from 20 wt % to 50 wt % of a propylene ethylene copolymer containing from 40.0 wt % to 65.0 wt % of ethylene derived units, measured by NMR;
wherein the polyolefin composition, having:
i) a content of ethylene derived units, measured by NMR, between 12.0 wt % and 35 wt %, based upon the total weight of the polyolefin composition;
ii) a content of ethylene derived units, measured by NMR, in the fraction soluble in xylene at 25° between 35.0 wt % and 56.0 wt %, based upon the total weight of soluble fraction;
iii) a melt flow rate (ISO 1133 (230° C., 21.6 kg) ranging from 0.1 g/10 min to 3.0 g/10 min;
iv) xylene solubles at 25° C. ranging from 23 wt % to 43.0 wt %, based upon the total weight of the polyolefin composition;
v) an intrinsic viscosity, measured in tetrahydronaphthalene at 135° C., of the fraction soluble in xylene at 25° C. ranging from 7.7 dl/g to 15.0 dl/g; and
vi) an intrinsic viscosity, measured in tetrahydronaphthalene at 135° C., of the whole polyolefin composition ranging from 7.7 dl/g to 15.0 dl/g;
the sum A+B being 100.

2. The polyolefin composition according to claim 1, wherein the content of ethylene derived units, measured by NMR, in component A), is between 3.5 wt % and 5.5 wt %.

3. The polyolefin composition according to claim 1, wherein component A) ranges from 57 wt % to 77 wt %, and component B) ranges from 23 wt % to 43 wt %.

4. The polyolefin composition according to claim 1, wherein the content of ethylene derived units, measured by NMR, in component B), ranges from 45 wt % to 58 wt %.

5. The polyolefin composition according to claim 1, wherein the content of ethylene derived units, measured by NMR, is between 15.0 wt % and 30 wt %.

6. The polyolefin composition according to claim 1, wherein the content of ethylene derived units, measured by NMR, in the fraction soluble in xylene at 25° C. is between 43.0 wt % and 49.0 wt %.

7. The polyolefin composition according to claim 1, wherein the content of ethylene derived units, measured by NMR, in the fraction soluble in xylene at 25° C. is between 38.0 wt % and 51.0 wt %.

8. The polyolefin composition according to claim 1, wherein the melt flow rate (ISO 1133 (230° C., 21.6 kg)) ranges from 0.5 g/10 min to 2.5 g/10 min.

9. The polyolefin composition according to claim 1, wherein the xylene solubles at 25° C. ranges from 28 wt % to 40.0 wt %.

10. The polyolefin composition according to claim 1, wherein the intrinsic viscosity, measured in tetrahydronaphthalene at 135° C., of the fraction soluble in xylene at 25° C. ranges from 7.9 dl/g to 13.0 dl/g.

11. The polyolefin composition according to claim 1, wherein the intrinsic viscosity, measured in tetrahydronaphthalene at 135° C., of the whole composition ranges from 7.9 dl/g to 13.0 dl/g.

12. The polyolefin composition according to claim 1, wherein the intrinsic viscosity, measured in tetrahydronaphthalene at 135° C., of the fraction insoluble in xylene at 25° C. ranges from 6.5 dl/g to 11.3 dl/g.

13. The polyolefin composition according to claim 1, wherein the content of ethylene derived units, measured by NMR, of the fraction insoluble in xylene at 25° C. is between 8.3 wt % and 17.3 wt %.

14. A molded article comprising the polyolefin composition according to claim 1.

15. A compression molded article comprising the polyolefin composition according to claim 1.
